(19) United States
(12) Patent Application Publication
(10) Pub. No.: US 2015/0022472 A1
(43) Pub. Date: Jan. 22, 2015

(54) FLEXIBLE DEVICE, METHOD FOR CONTROLLING DEVICE, AND METHOD AND APPARATUS FOR DISPLAYING OBJECT BY FLEXIBLE DEVICE

(71) Applicant: SAMSUNG ELECTRONICS CO., LTD., Suwon-si (KR)

(72) Inventors: Ji-hyun JUNG, Seongnam-si (KR); Shi-yun CHO, Anyang-si (KR)

(73) Assignee: SAMSUNG ELECTRONICS CO., LTD., Suwon-si (KR)

(21) Appl. No.: 14/336,300

(22) Filed: Jul. 21, 2014

(30) Foreign Application Priority Data
Jul. 19, 2013 (KR) 10-2013-0085684

(51) Int. Cl. G06F 3/041

(52) U.S. Cl. CPC G06F 3/0412; G06F 2203/04102
USPC 345/173

(57) ABSTRACT

An object display method including receiving a touch input and a bending input, selecting an object related to an application displayed on a screen of the device in response to the receiving the touch input and the bending input; and displaying the selected object at a predetermined location on the screen, wherein the predetermined location is based on a location on the screen where the touch input is received.

### RELATED APPLICATION

This application claims the benefit of Korean Patent Application No. 10-2013-0085684, filed on Jul. 19, 2013, in the Korean Intellectual Property Office, the disclosure of which is incorporated herein in its entirety by reference.

### BACKGROUND

1. Field

One or more exemplary embodiments relate to a method and apparatus for displaying an object by a flexible device, and more particularly, to a method and apparatus for displaying an object at a predetermined location of a flexible device, based on a user's input.

2. Description of the Related Art

Along with the variety of functions of a device, multimedia devices having complex functions, e.g., picture or video capturing, music or video file playing, gaming, and broadcast reception functions, have been realized. To relatively efficiently use these functions of a device, the improvement of structural and software portions of the device may be considered.

In general, devices have been developed with various types of designs, and along with the development, a flexible device has received attention because of its light-weight and break resistant characteristics. The flexible device may contribute to the creation of a user interface region which is limited or impossible with the existing glass substrate-based displays.

### SUMMARY

One or more exemplary embodiments include a method and apparatus by which a flexible device displays an object in a predetermined region of the flexible device, based on a user's input.

Additional aspects will be set forth in part in the description which follows and, in part, will be apparent from the description, or may be learned by practice of the presented embodiments.

According to one or more exemplary embodiments, a method of displaying an object by a device includes: receiving a touch input and a bending input; selecting an object related to an application displayed on a screen of the device in response to the receiving the touch input and the bending input; and displaying the selected object at a predetermined location on the screen, wherein the predetermined location is based on a location on the screen where the touch input is received.

The bending input may include at least one of bending the device and unbending the device.

The selecting may further include detecting a difference between a time the touch input is received and a time the bending input is received, and the object may be selected when the reception time difference is less than or equal to a predetermined threshold.

The selecting may include: identifying a type of the bending input according to at least one of a location, the number of times, an angle, a direction, and a hold time of the received bending input; and selecting the object based on the identified type of the bending input.

The object may include information regarding the execution of an additional function related to the application while the application is being executed, and the additional function may be set in advance for the application.

The object may include an execution result of a relevant application related to the application, and the relevant application may be set in advance for the application.

The selecting may include selecting a plurality of objects, and the displaying may further include sequentially displaying the plurality of objects on the screen in a preset order.

The plurality of objects may be sequentially displayed based on an input of the user.

The displaying may further include: identifying a location of the received touch input; determining a region in which the object is to be displayed, based on the identified location; and displaying the object in the determined region.

The displaying may further include removing the object from the screen in response to a display end signal being received, and the display end signal may be generated in response to at least one of a touch input and a bending input of the user to the device on which the object is displayed is received.

According to one or more exemplary embodiments, a device for displaying an object includes: a touch screen configured to receive a touch input; a bending detector configured to detect a bending input; and a controller configured to select an object related to an application displayed on the touch screen of the device in response to the reception of the touch input and the bending input and to display the selected object at a predetermined location on the touch screen, wherein the predetermined location is based on a location on the touch screen where the touch input is received.

The bending input may include at least one of bending the device and unbending the device.

The controller may be further configured to detect a difference between a time the touch input is received and a time the bending input is received and to select the object when the reception time difference is less than or equal to a predetermined threshold.

The controller may be further configured to identify a type of the bending input according to at least one of a location, a number of times, an angle, a direction, and a hold time of the received bending input and to select the object based on the identified type of the bending input.

The object may include information regarding the execution of an additional function related to the application while the application is being executed, and the additional function is set in advance for the application.

The object may include an execution result of a relevant application related to the application, and the relevant application is set in advance for the application.

The controller may be further configured to select a plurality of objects and to sequentially display the plurality of objects on the touch screen in a preset order.

The controller may be further configured to sequentially display the plurality of objects based on user input.

The controller may be further configured to identify a location of the received touch input, determine a region in which the object is to be displayed, based on the identified location, and display the object in the determined region.

The controller may be further configured to remove the object from the screen in response to a display end signal being received, and the display end signal may be generated in response to at least one of a touch input being received by the touch screen and a bending input being detected by the bending detector.

According to one or more exemplary embodiments, a flexible device includes a touch screen configured to detect a touch input; a bending sensor configured to detect a bending of the device; and a controller configured to execute a predetermined function in response to the detection of a touch input and a bending input.

The predetermined function may include displaying an object on the touch screen, and the object may be selected based on at least one of a location, a number of times, an angle, a direction, and a hold time of the detected bending.

According to one or more exemplary embodiments, a method of controlling a device includes detecting a touch on a screen of the device and a bending of the device; and executing a predetermined function in response to the detecting.

The predetermined function may include displaying an object on the screen of the device, and the object may be selected based on at least one of a location, a number of times, an angle, a direction, and a hold time of the detected bending.

According to one or more exemplary embodiments, a non-transitory computer-readable storage medium may have stored therein program instructions, which when executed by a computer, perform one or more of the above described methods.

### BRIEF DESCRIPTION OF THE DRAWINGS

These and/or other aspects will become apparent and more readily appreciated from the following description of one or more exemplary embodiments, taken in conjunction with the accompanying drawings in which:

FIG. 1 is a conceptual diagram for describing a method by which a device displays an object related to an application displayed on a screen, according to an exemplary embodiment;

FIG. 2 is a flowchart of a method by which a device displays an object related to an application displayed on a screen, according to an exemplary embodiment;

FIG. 3 is a detailed flowchart of a method by which the device in FIG. 1 selects an object to be displayed on a screen;

FIG. 4 is a detailed flowchart of a method by which the device in FIG. 1 determines a region in which an object is to be displayed on a screen;

FIG. 5 illustrates an operation of a device responding to a bending input, according to an exemplary embodiment;

FIG. 6 is a table for describing operations of a device according to types of a bending input, according to an exemplary embodiment;

FIGS. 7A to 7E illustrate types of a bending input according to an exemplary embodiment;

FIG. 8 illustrates a method of displaying an object by receiving a touch input and a bending input when an instant messenger application is executed, according to an exemplary embodiment;

FIG. 9 illustrates a method of displaying an object by receiving a touch input and a bending input when a gallery application is executed, according to an exemplary embodiment;

FIG. 10 illustrates a method of displaying an object by receiving a touch input and a bending input when a home screen application is executed, according to an exemplary embodiment;

FIG. 11 illustrates a method of displaying an object by receiving a touch input and a bending input when a document viewer application is executed, according to an exemplary embodiment;

FIG. 12 is a block diagram of a device for displaying an object related to an application displayed on a screen, according to an exemplary embodiment;

FIGS. 13A and 13B illustrate a location of a bending sensor included in a device, according to an exemplary embodiment;

FIGS. 14A and 14B illustrate a location of a bending sensor included in a device, according to another exemplary embodiment; and

FIGS. 15A and 15B illustrate a location of a bending sensor included in a device, according to another exemplary embodiment.

### DETAILED DESCRIPTION

Hereinafter, one or more exemplary embodiments will be described in detail with reference to the accompanying drawings so that one of ordinary skill in the art may easily realize the present invention. However, the present invention may be embodied in many different forms and should not be construed as being limited to the embodiments set forth herein. In the drawings, parts irrelevant to the description are omitted to clearly describe the present invention, and like reference numerals denote like elements throughout the specification.

In the description below, when it is described that a certain component is connected to another component, the certain component may be directly connected to another component, or a third component may be electrically interposed therebetween. In the specification, when a certain part “includes” a certain component, this indicates that the part may further include another component instead of excluding another component unless there is different disclosure.

As used herein, the term “and/or” includes any and all combinations of one or more of the associated listed items. Expressions such as “at least one of,” when preceding a list of elements, modify the entire list of elements and do not modify the individual elements of the list.

Exemplary embodiments will now be described in detail with reference to the accompanying drawings.

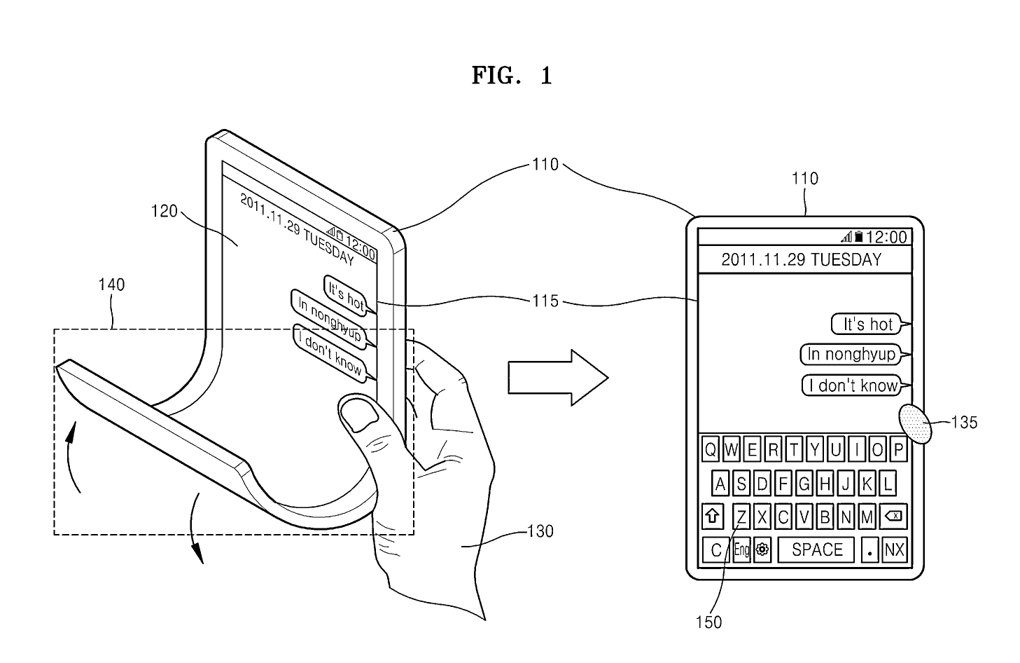

FIG. 1 is a conceptual diagram for describing a method by which a device 110 displays an object 150 related to an application 120 displayed on a screen 115, according to an exemplary embodiment.

Referring to FIG. 1, the device 110 may receive a touch input 130 and a bending input 140 of a user. According to an exemplary embodiment, an input method may be provided to the user by combining a touch input method and a bending input method which are independently used. The input method in which the touch input 130 and the bending input 140 are combined may provide an intuitive use environment to the user using the device 110. The bending input 140 may occur by an operation of bending the device 110 by the user and/or an operation of unbending the device 110 by the user.

The device 110 according to an exemplary embodiment may include a smartphone, a personal computer (PC), a tablet PC, and the like.

The device 110 may select the object 150 related to the application 120 displayed on the screen 115 of the device 110 in response to the reception of the touch input 130 and the bending input 140. The object 150 may be a user interface as information which may be displayed on the screen 115 of the device 110. In addition, the object 150 may include at least one piece of data selected from the group consisting of, for example, a text, an icon, an image, and a video.

In detail, the object 150 may include an execution result of a relevant application related to the application 120, wherein the relevant application may be set in advance for each application. In addition, the object 150 may be displayed on the screen 115 so as to execute an additional function related to the application 120 while the application 120 is being executed. The additional function may be set in advance for each application.

The selected object 150 may be displayed on the screen 115 of the device 110, based on a location 135 on the screen 115 where the touch input 130 is received. According to an embodiment exemplary, the user may determine a region in which the object 150 is to be displayed, by selecting a location of the touch input 130.

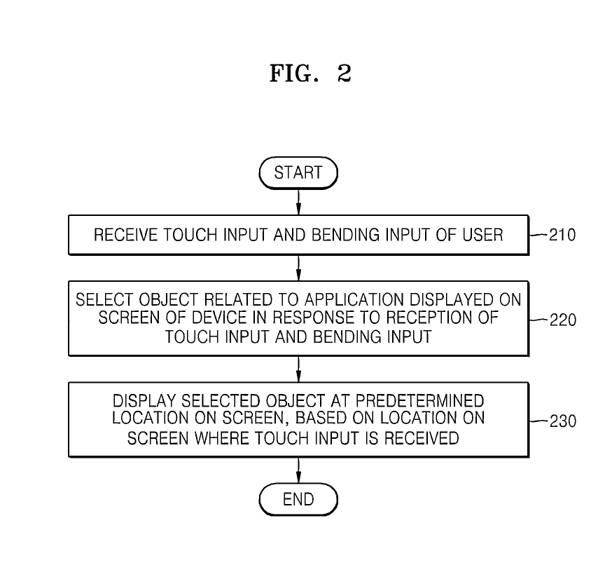

FIG. 2 is a flowchart of a method by which the device 110 displays the object 150 related to the application 120 displayed on the screen 115, according to an embodiment exemplary.

In operation 210, the device 110 receives the touch input 130 and the bending input 140 of the user. According to an exemplary embodiment, an input method may be provided to the user by combining a touch input method and a bending input method which are independent input methods.

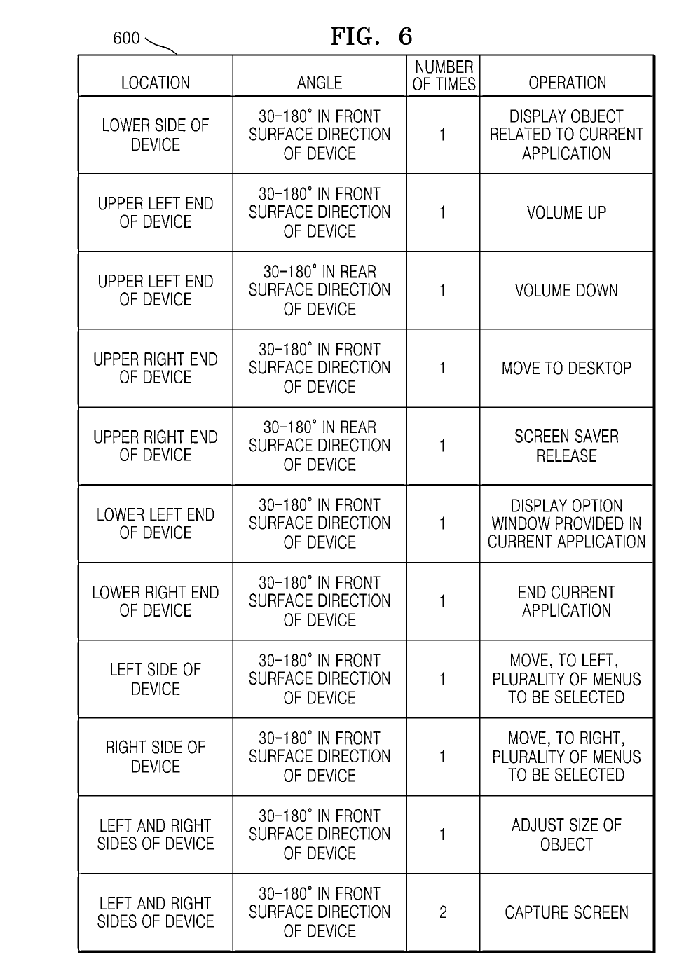

The bending input 140 may occur by an operation of bending the device 110 by the user and/or an operation of unbending the device 110 by the user. A type of the bending input 140 may be identified according to at least one of a location, the number of times, an angle, a direction, and a hold time of the received bending input 140. Types of the bending input 140 will be described below in detail with reference to FIG. 6.

In operation 220, the device 110 selects the object 150 related to the application 120 displayed on the screen 115 of the device 110 in response to the reception of the touch input 130 and the bending input 140. According to an exemplary embodiment, the application 120 displayed on the screen 115 may include a social network service (SNS) application, an instant messenger application, a gallery application, a home screen application, and a document viewer application.

The object 150 may include information displayed on the screen 115 so as to execute an additional function related to the application 120 while the application 120 is being executed. For example, when the application 120 displayed on the screen 115 is an instant messenger application, the object 150 may include a keyboard typing system through which a message is inputted. The additional function may be set in advance for each application.

In addition, the object 150 may include an execution result of a relevant application related to the application 120. For example, when the application 120 displayed on the screen 115 is a gallery application, the object 150 may include a picture editing application. On the screen 115 of the device 110, an execution window with tools required to edit pictures may be displayed as an execution result of the picture editing application.

In operation 230, the device 110 displays the selected object 150 at a predetermined location on the screen 115, based on the location 135 on the screen 115 where the touch input 130 is received.

According to an exemplary embodiment, when the touch input 130 of the user is received, the device 110 may identify the location 135 where the touch input 130 of the user is received. The device 110 may determine a region in which the selected object 150 is to be displayed, based on the location 135 of the touch input 130.

In detail, the selected object 150 may be displayed in at least one region selected from a lower end portion and an upper end portion of a horizontal line generated based on the location 135 where the touch input 130 is received.

When the received touch input 130 is plural in number, the selected object 150 may be displayed in at least one region selected from a lower end portion and an upper end portion of a horizontal line generated based on an average value of locations 135 of the plurality of the touch inputs 130. However, this is merely one exemplary embodiment, and the device 110 may display the object 150 based on the highest or lowest one of the locations 135 of the plurality of the touch inputs 130.

According to an exemplary embodiment, when a display end signal is received from the user, the object 150 may be removed from the screen 115. The display end signal may be generated when a touch input and/or a bending input of the user to the device 110 on which the object 150 is displayed is received.

In detail, when the user desires to remove the object 150 and view the screen 115 on which only the application 120 is displayed, the user may remove the object 150 from the screen 115 by generating a display end signal.

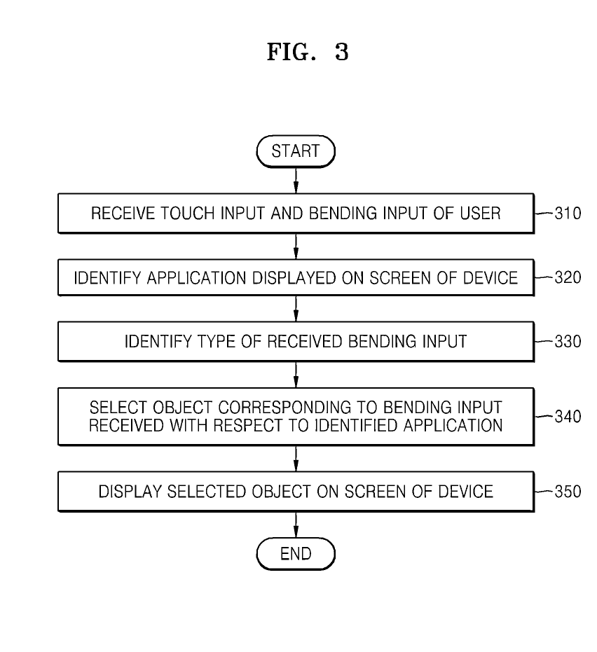

FIG. 3 is a detailed flowchart of a method by which the device 110 in FIG. 1 selects the object 150 to be displayed on the screen 115.

In operation 310, the device 110 receives the touch input 130 and the bending input 140 of the user. The bending input 140 may occur by an operation of bending the device 110 by the user and/or an operation of unbending the device 110 by the user.

When the touch input 130 and the bending input 140 of the user are received, the device 110 may detect a difference between a time the touch input 130 is received and a time the bending input 140 is received. When the reception time difference is a predetermined threshold or less, the device 110 may perform a series of operations of determining the object 150 to be displayed on the screen 115. However, this is merely one exemplary embodiment, and the object 150 may be displayed when the touch input 130 and the bending input 140 are received without limitation on a time each of the touch input 130 and the bending input 140 is received.

In operation 320, the device 110 identifies the application 120 displayed on the screen 115. According to an exemplary embodiment, the application 120 displayed on the screen 115 may include an SNS application, an instant messenger application, a gallery application, a home screen application, and a document viewer application.

In operation 330, the device 110 identifies a type of the received bending input 140. The type of the received bending input 140 may be identified according to a location, the number of times, an angle, a direction, and a hold time of the received bending input 140. According to an exemplary embodiment, when a bending input which has occurred according to an operation of bending the whole lower end of the device 110 is received, the object 150 related to the application 120 displayed on the screen 115 may be displayed. In addition, when a bending input which has occurred according to an operation of simultaneously bending left and right sides of the device 110 is received in a state where the object 150 related to the application 120 is displayed, a size of the object 150 displayed on the screen 115 may be adjusted. Types of the bending input 140 will be described below in detail with reference to FIG. 6.

In operation 340, the device 110 selects the object 150 corresponding to the bending input 140 received with respect to the application 120 identified in operation 320. According to a type of the identified application 120, an additional function or a relevant application required while the user is using the application 120 may vary. That is, according to a type of the identified application 120, the displayed object 150 may vary. The object 150 is information displayed on the screen 115 so as to execute an additional function related to the application 120 while the application 120 is being executed. The additional function may be set in advance for each application.

In addition, the object 150 may include an execution result of a relevant application related to the application 120, wherein the relevant application may be set in advance for each application.

For example, when the application 120 displayed on the screen 115 is a gallery application, the additional function may include a function of transmitting a picture. In addition, the relevant application related to the gallery application may include a picture editing application.

When the application 120 displayed on the screen 115 is a document viewer application, the additional function may include an index function capable of marking a read portion of the whole document. In addition, the relevant application related to the document viewer application may include a dictionary application.

In operation 350, the device 110 displays the object 150 selected in operation 340 on the screen 115 of the device 110. The device 110 may display the selected object 150 at a predetermined location on the screen 115, based on the location 135 on the screen 115 where the touch input 130 is received.

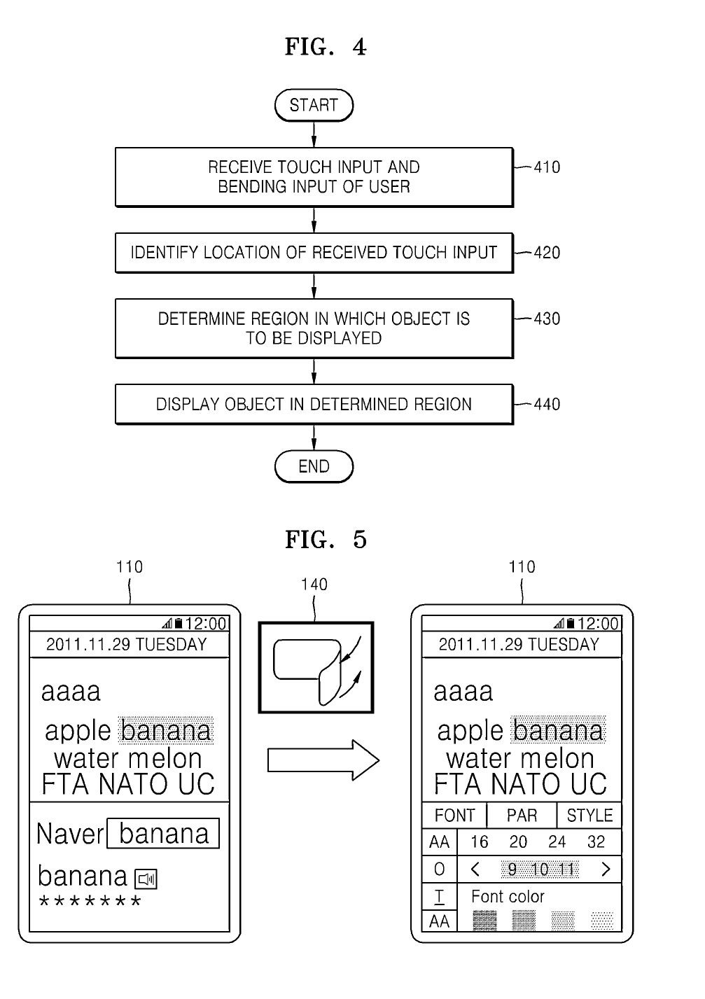

According to an exemplary embodiment, when the touch input 130 of the user is received, the device 110 may confirm the location 135 where the touch input 130 is received. The device 110 may determine a region in which the selected object 150 is to be displayed, based on the location 135 of the touch input 130. A method of determining a region will be described below in detail with reference to FIG. 4.

When the selected object 150 is a plurality of selected objects 150, the plurality of objects 150 may be sequentially displayed on the screen 115 in a preset order by additional bending in a state of displaying one object 150. For example, when the application 120 displayed on the screen 115 is a document viewer application, a relevant application related to the document viewer application may include a dictionary application, a document editing application, and an SNS application capable of sharing a document. When the preset order in the device 110 is an order of dictionary, document editing, and SNS, an execution result of the dictionary application, an execution result of the document editing application, and an execution result of the SNS application may be sequentially displayed on the screen 115 by additional bending.

When the selected object 150 is plural in number, an order of displaying the plurality of objects 150 may be determined based on an input of the user.

FIG. 4 is a detailed flowchart of a method by which the device 110 in FIG. 1 determines a region in which the object 150 is to be displayed on the screen 115.

In operation 410, the device 110 receives the touch input 130 and the bending input 140 of the user. The bending input 140 may occur by an operation of bending the device 110 by the user and/or an operation of unbending the device 110 by the user.

In operation 420, the device 110 identifies the received touch input 130. The received touch input 130 may be a reference point for determining a region in which the object 150 is to be displayed on the screen 115. The device 110 may specify the reference point for displaying the object 150 after identifying a location where the touch input 130 is received.

In detail, the location where the touch input 130 is received may occupy a predetermined region on the screen 115 of the device 110. For example, when the user touches the device 110 by using one hand, the predetermined region may include an area of a finger that touches the screen 115. According to an exemplary embodiment, a center point of the predetermined region may be specified as the reference point.

However, this is merely one exemplary embodiment, and a method of specifying the reference point may be changed according to setting of the user. For example, the device 110 may display the object 150 based on the highest or lowest one of locations of a plurality of touch inputs 130.

In operation 430, the device 110 determines a region in which the object 150 is to be displayed. In detail, the selected object 150 may be displayed in at least one region selected from a lower end portion and an upper end portion of a horizontal line generated based on the reference point specified in operation 420.

When the touch input 130 received on the screen 115 of the device 110 is a plurality of touch inputs 130, there may be a corresponding plurality of reference points specified in operation 420. For example, when the user bends the device 110 by holding the device 110 with both hands, a plurality of touch inputs 130 may be received. When a plurality of reference points is specified according to the plurality of touch inputs 130, the device 110 may generate a horizontal line based on an intermediate point of the plurality of reference points.

At least one region selected from a lower end portion and an upper end portion of the generated horizontal line may be determined as the region in which the object 150 is to be displayed, based on the generated horizontal line. Whether the object 150 is to be displayed in the lower end portion and/or the upper end portion of the generated horizontal line may be variably set according to a type of the object 150.

In operation 440, the device 110 displays the object 150 in the region determined in operation 430. A size of the object 150 may be adjusted depending on the determined region. The user may effectively use the application 120 and the object 150 displayed on the screen 115 by displaying the object 150 with a desired size in a desired region on the screen 115 through the touch input 130.

FIG. 5 illustrates an operation of the device 110 responding to a bending input, according to an exemplary embodiment.

Referring to FIG. 5, a dictionary application that is a relevant application of a document viewer application is displayed on the screen 115 of the device 110. When the bending input 140, which has occurred according to an operation of bending the whole right side of the device 110 towards a front direction of the device 110, and the touch input 130 are received in a state where the dictionary application is displayed, a subsequent object of a currently displayed object may be displayed according to a preset order. The subsequent object may be displayed at a predetermined location on the screen 115, based on a location where the touch input 130 is received.

Referring to FIG. 5, when the application 120 displayed on the screen 115 is a document viewer application, a relevant application related to the document viewer application may include a dictionary application, a document editing application, and an SNS application capable of sharing a document.

It may be assumed that an application display order preset in the device 110 is dictionary, document editing, and SNS, and the dictionary application is displayed on the screen 115. When the touch input 130 and the bending input 140 which has occurred according to an operation of bending the right side of the device 110 are received, the currently displayed dictionary application is removed, and the document editing application may be displayed at a predetermined location on the screen 115 based on a location where the touch input 130 is received.

The illustration of FIG. 5 is merely one exemplary embodiment, and an additional bending input operation is not limited thereto. For example, an object to be displayed on the screen 115 may be changed by an operation of bending a left side or a corner of the device 110, according to a setting of the user.

FIG. 6 is a table 600 for describing operations of the device 110 according to types of the bending input 140, according to an exemplary embodiment. The types of the bending input 140 may be identified according to at least one of a location, the number of times, an angle, a direction, and a hold time of reception of the bending input 140. One or more operations from the table 600 will be described below in further detail.

Referring to FIG. 6, when the bending input 140, which has occurred according to an operation of bending the whole lower end of the device 110 towards the front direction of the device 110, and the touch input 130 are received, the object 150 related to the application 120 displayed on the screen 115 may be displayed. In detail, the object 150 related to the application 120 may be displayed at a predetermined location on the screen 115, based on a location on the screen 115 where the touch input 130 is received.

When the bending input 140, which has occurred according to an operation of bending a lower left end corner of the device 110 towards the front direction of the device 110, and the touch input 130 are received, an option window provided by the application 120 displayed on the screen 115 may be displayed. The option window may provide a list for setting information required to execute the application 120. For example, when the application 120 is an SNS application, a list of log-out, a personal information configuration, and the like may be displayed on the option window. The option window may be displayed at a predetermined location on the screen 115, based on a location where the touch input 130 is received.

When the bending input 140, which has occurred according to an operation of bending left and right sides of the device 110 towards the front direction of the device 110, and the touch input 130 are received, a plurality of objects 150 related to the application 120 displayed on the screen 115 may be sequentially displayed.

In detail, the object 150 related to the application 120 is plural in number, the device 110 may display the plurality of objects 150 according to an input of the user so that the user selects one object 150 among the plurality of objects.

When the right side of the device 110 is bent towards the front direction of the device 110, a subsequent object of a currently displayed object may be displayed according to a preset order. The subsequent object may be displayed at a predetermined location on the screen 115, based on a location where the touch input 130 is received.

When the left side of the device 110 is bent towards the front direction of the device 110, a previous object of a currently displayed object may be displayed according to a preset order. The previous object may be displayed at a predetermined location on the screen 115, based on a location where the touch input 130 is received.

For example, when the application 120 displayed on the screen 115 is a document viewer application, a relevant application related to the document viewer application may include a dictionary application, a document editing application, and an SNS application capable of sharing a document.

It may be assumed that an application display order preset in the device 110 is dictionary, document editing, and SNS, and the dictionary application is displayed on the screen 115. When the touch input 130 and the bending input 140 which has occurred according to an operation of bending the right side of the device 110 are received, the document editing application may be displayed at a predetermined location on the screen 115 based on a location where the touch input 130 is received.

When the touch input 130 and the bending input 140 which has occurred according to an operation of bending the left side of the device 110 are received, the SNS application may be displayed at a predetermined location on the screen 115 in a reverse order of the preset order, based on a location where the touch input 130 is received.

The types of the bending input 140 may vary according to the number of bending inputs received on the screen 115 of the device 110. Referring to FIG. 6, two continuous bending inputs 140, which have occurred according to an operation of simultaneously bending the left and right sides of the device 110, and the touch input 130 are received, the screen 115 may be captured. In detail, a predetermined region on the screen 115 may be captured based on a location where the touch input 130 is received.

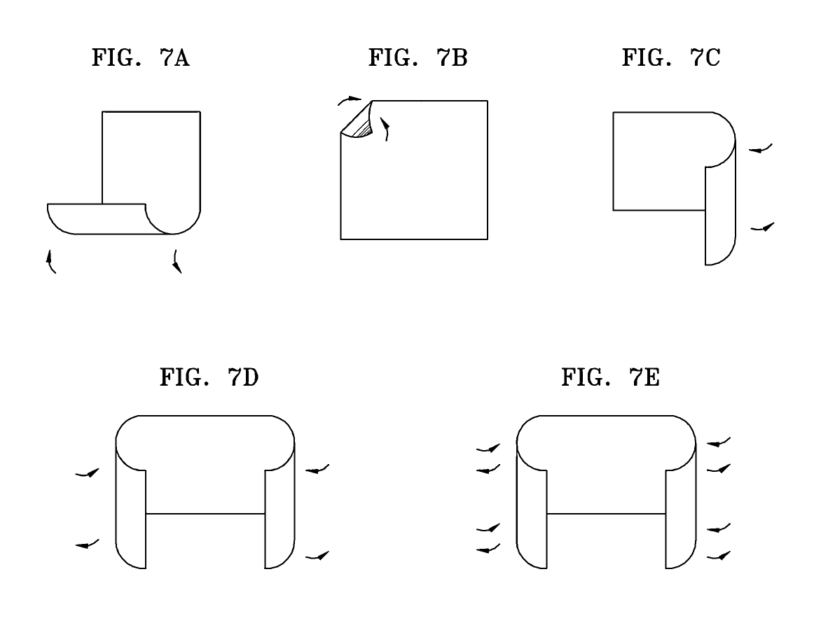

FIGS. 7A to 7E illustrate types of a bending input according to an exemplary embodiment.

The bending input of FIG. 7A may occur by an operation of bending a lower side of the device 110 towards the front direction of the device 110 once. According to an exemplary embodiment, an object related to an application displayed on the device 110 may be displayed on a screen through the bending input of FIG. 7A.

The bending input of FIG. 7B may occur by an operation of bending an upper left end of the device 110 towards the front direction of the device 110 once. According to an exemplary embodiment, a volume of the device 110 may be raised through the bending input of FIG. 7B.

The bending input of FIG. 7C may occur by an operation of bending the right side of the device 110 towards the front direction of the device 110 once. According to an exemplary embodiment, an object desired by the user may be selected from among a plurality of objects through the bending input of FIG. 7C.

The bending input of FIG. 7D may occur by an operation of bending the left and right sides of the device 110 towards the front direction of the device 110 once. According to an exemplary embodiment, a size of a displayed object may be adjusted through the bending input of FIG. 7D.

The bending input of FIG. 7E may occur by an operation of bending the left and right sides of the device 110 towards the front direction of the device 110 twice. According to an exemplary embodiment, a screen may be captured through the bending input of FIG. 7E.

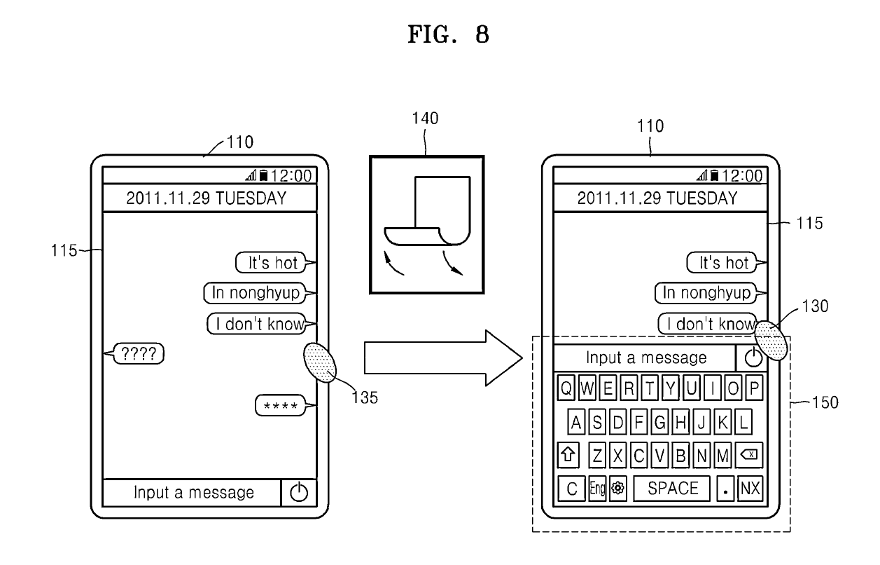

FIG. 8 illustrates a method of displaying the object 150 by receiving the touch input 130 and the bending input 140 when an instant messenger application is executed, according to an exemplary embodiment.

The device 110 may receive the touch input 130 and the bending input 140 of the user. The bending input 140 may occur by an operation of bending the device 110 towards the front direction of the device 110 by the user.

The device 110 may select the object 150 related to the instant messenger application displayed on the screen 115 of the device 110 in response to the reception of the touch input 130 and the bending input 140.

The object 150 may include information displayed on the screen 115 so as to execute an additional function related to the application 120 while the application 120 is being executed. For example, when the application 120 displayed on the screen 115 is an instant messenger application, the object 150 may include a keyboard typing system through which a message is inputted.

The device 110 may display the keyboard typing system at a predetermined location on the screen 115, based on the location 135 where the touch input 130 is received.

According to an exemplary embodiment, when the touch input 130 of the user is received, the device 110 may identify the location 135 where the touch input 130 is received. The device 110 may determine a region in which the keyboard typing system that is the selected object 150 is to be displayed, based on the location 135 where the touch input 130 is received.

In detail, the selected object 150 may be displayed in at least one region selected from a lower end portion and an upper end portion of a horizontal line generated based on the location 135 where the touch input 130 is received. In FIG. 8, the keyboard typing system may be displayed on the lower end portion of the horizontal line generated based on the received location 135.

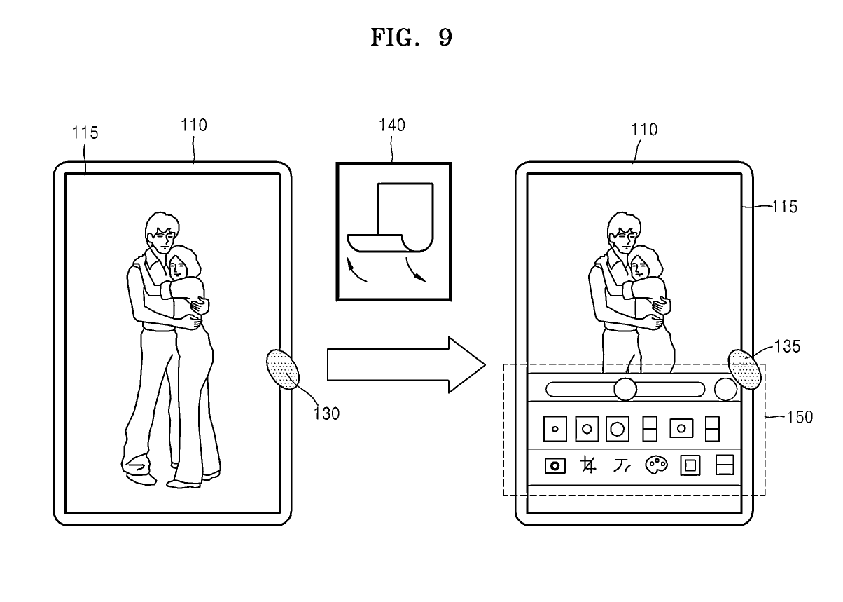

FIG. 9 illustrates a method of displaying the object 150 by receiving the touch input 130 and the bending input 140 when a gallery application is executed, according to an exemplary embodiment.

The device 110 may receive the touch input 130 and the bending input 140 of the user. The bending input 140 may occur by an operation of bending the device 110 towards the front direction of the device 110 by the user.

The device 110 may select the object 150 related to the gallery application displayed on the screen 115 of the device 110 in response to the reception of the touch input 130 and the bending input 140.

The object 150 may include information displayed on the screen 115 so as to execute an additional function related to the application 120 while the application 120 is being executed. In addition, the object 150 may include an execution result of a relevant application related to the application 120.

For example, when the application 120 displayed on the screen 115 is the gallery application, the relevant application may include a picture editing application. On the screen 115 of the device 110, an execution window with tools required to edit pictures may be displayed as an execution result of the picture editing application.

The device 110 may display an execution result of the picture editing application at a predetermined location on the screen 115, based on the location 135 on the screen 115 where the touch input 130 is received.

According to an exemplary embodiment, when the touch input 130 of the user is received, the device 110 may identify the location 135 where the touch input 130 of the user is received. The device 110 may determine a region in which the execution result of the picture editing application that is the selected object 150 is to be displayed, based on the location 135 of the touch input 130.

In detail, the selected object 150 may be displayed in at least one region selected from a lower end portion and an upper end portion of a horizontal line generated based on the location 135 where the touch input 130 is received. In FIG. 9, the execution result of the picture editing application may be displayed on the lower end portion of the horizontal line generated based on the received location 135.

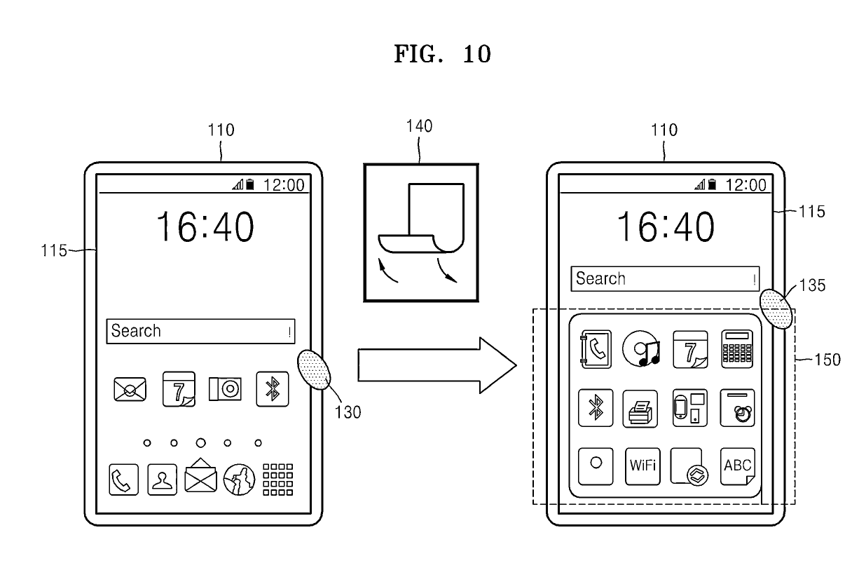

FIG. 10 illustrates a method of displaying the object 150 by receiving the touch input 130 and the bending input 140 when a home screen application is executed, according to an exemplary embodiment.

The device 110 may receive the touch input 130 and the bending input 140 of the user. The bending input 140 may occur by an operation of bending the device 110 towards the front direction of the device 110 by the user.

The device 110 may select the object 150 related to the home screen application displayed on the screen 115 of the device 110 in response to the reception of the touch input 130 and the bending input 140.

The object 150 may include information displayed on the screen 115 so as to execute an additional function related to the application 120 while the application 120 is being executed. In addition, the object 150 may include an execution result of a relevant application related to the application 120.

For example, when the application 120 displayed on the screen 115 is the home screen application, the information displayed so as to execute the related additional function may include a favorites menu. The device 110 may display the favorites menu at a predetermined location on the screen 115, based on the location 135 on the screen 115 where the touch input 130 is received.

According to an exemplary embodiment, when the touch input 130 of the user is received, the device 110 may identify the location 135 where the touch input 130 of the user is received. The device 110 may determine a region in which the favorites menu is to be displayed, based on the location 135 of the touch input 130.

In detail, the selected object 150 may be displayed in at least one region selected from a lower end portion and an upper end portion of a horizontal line generated based on the location 135 where the touch input 130 is received. In FIG. 10, the favorites menu may be displayed on the lower end portion of the horizontal line generated based on the received location 135.

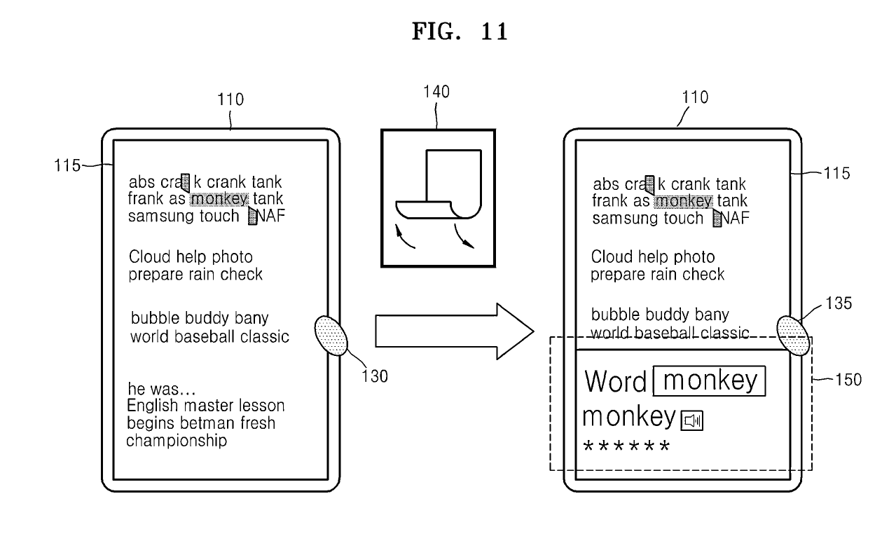

FIG. 11 illustrates a method of displaying the object 150 by receiving the touch input 130 and the bending input 140 when a document viewer application is executed, according to an exemplary embodiment.

The device 110 may receive the touch input 130 and the bending input 140 of the user. The bending input 140 may occur by an operation of bending the device 110 towards the front direction of the device 110 by the user.

The device 110 may select the object 150 related to the document viewer application displayed on the screen 115 of the device 110 in response to the reception of the touch input 130 and the bending input 140.

The object 150 may include information displayed on the screen 115 so as to execute an additional function related to the application 120 while the application 120 is being executed. In addition, the object 150 may include an execution result of a relevant application related to the application 120.

For example, when the application 120 displayed on the screen 115 is the document viewer application, the relevant application may include a dictionary application. On the screen 115 of the device 110, an execution window capable of searching for the meaning of a word in a document may be displayed as an execution result of the dictionary application.

The device 110 may display an execution result of the dictionary application at a predetermined location on the screen 115, based on the location 135 on the screen 115 where the touch input 130 is received.

According to an exemplary embodiment, when the touch input 130 of the user is received, the device 110 may identify the location 135 where the touch input 130 of the user is received. The device 110 may determine a region in which the execution result of the dictionary application that is the selected object 150 is to be displayed, based on the location 135 of the touch input 130.

In detail, the selected object 150 may be displayed in at least one region selected from a lower end portion and an upper end portion of a horizontal line generated based on the location 135 where the touch input 130 is received. In FIG. 11, the execution result of the dictionary application may be displayed on the lower end portion of the horizontal line generated based on the received location 135.

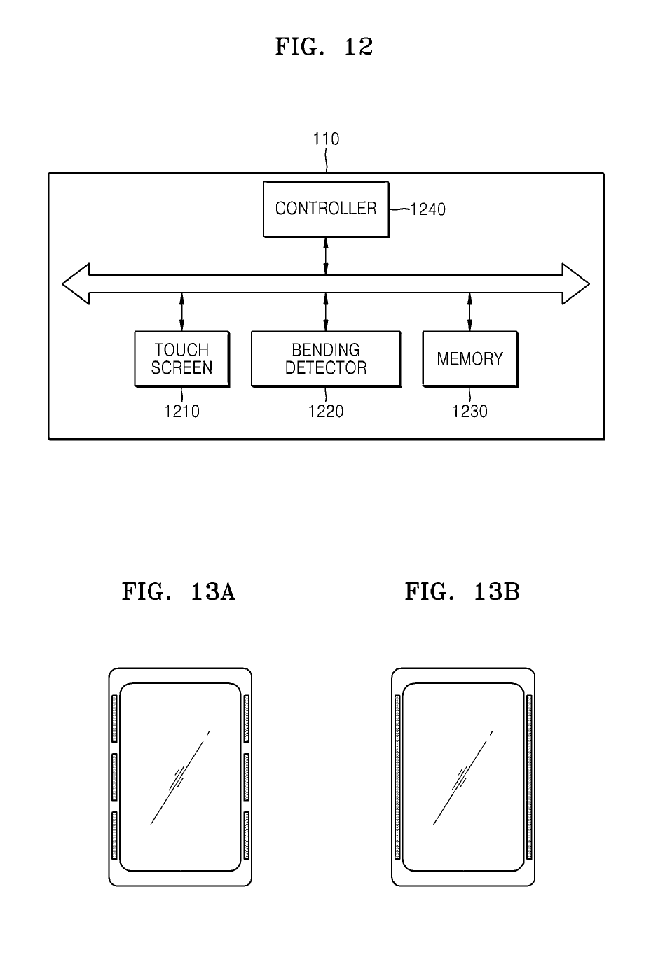

FIG. 12 is a block diagram of the device 110 for displaying the object 150 related to an application displayed on the screen 115, according to an exemplary embodiment. The screen 115 of the device 110 according to an exemplary embodiment may be a touch screen 1210 to be described below.

The touch screen 1210 may receive the touch input 130 of the user. The touch input 130 may occur by a drag or tap gesture. The object 150 may be displayed based on a location on the touch screen 1210 where the touch input 130 is received.

In detail, after a reference point is specified within the touch screen 1210 of the device 110 based on the location where the touch input 130 is received, the object 150 may be displayed in at least one region selected from a lower end portion and an upper end portion of a horizontal line generated based on the specified reference point.

A bending detector 1220, i.e. a bending detector unit, may receive the bending input 140 of the user. The bending input 140 may occur by an operation of bending the device 110 by the user and/or an operation of unbending the device 110 by the user. The bending detector 1220 may detect a degree of bending of the device 110 through a bending sensor.

FIGS. 13A and 13B illustrate a location of the bending sensor included in the device 110, according to an exemplary embodiment.

Referring to FIGS. 13A and 13B, the bending sensor may be located at the left and right sides of the device 110 with a predetermined gap as shown in FIG. 13A. A case where the bending sensor is mounted with a predetermined gap may have a lower accuracy in detection of a bending input but have a higher efficiency in view of costs than a case where the bending sensor is mounted at the whole left and right sides.

The bending sensor may be located at the whole left and right sides of the device 110 as shown in FIG. 13B. The case where the bending sensor is mounted at the whole left and right sides of the front of the device 110 may have a lower efficiency in view of costs but have a higher accuracy in detection of a bending input than the case where the bending sensor is mounted with a predetermined gap.

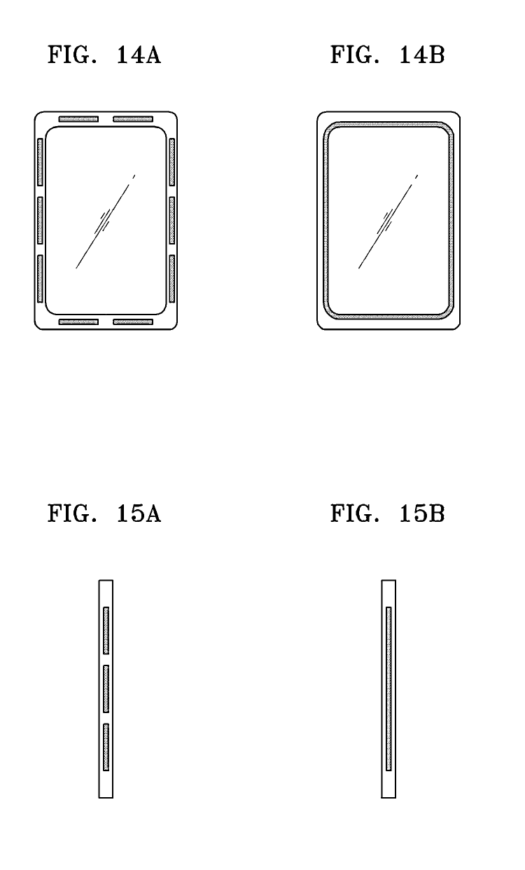

FIGS. 14A and 14B illustrate a location of the bending sensor included in the device 110, according to another exemplary embodiment.

Referring to FIGS. 14A and 14B, the bending sensor may be located at the whole edge of the device 110 with a predetermined gap as shown in FIG. 14A. By mounting the bending sensor at the whole edge of the device 110 with a predetermined gap, a bending input discriminated according to an angle, the number of times, and a location may be accurately detected.

The bending sensor may be mounted on the whole surface of the touch screen 1210 of the device 110 as shown in FIG. 14B. In particular, when the bending sensor is transparent, the bending sensor may be mounted at the whole front or rear surface part of the device 110.

FIGS. 15A and 15B illustrate a location of the bending sensor included in the device 110, according to another exemplary embodiment.

Referring to FIGS. 15A and 15B, the bending sensor may be located at a side surface of the device 110 with a predetermined gap as shown in FIG. 15A. When the bending sensor is disposed at the side surface of the device 110, the spatial utilization of the device 110 may be high. In particular, when the bending sensor is opaque, a space of the device 110 may be efficiently used by disposing the bending sensor at the side surface of the device 110. In addition, by disposing the bending sensor at the side surface of the device 110, restriction on a design of the device 110 may also be reduced.

In addition, by disposing the bending sensor at the side surface of the device 110 and disposing another sensor at the front or rear surface part of the device 110, an input method differentiated from the existing input methods may be applied. For example, when a touch sensor is disposed at the rear surface part of the device 110, and the bending sensor is disposed at the side surface, the user may select an object by using the touch sensor and input a signal through the bending sensor so as to perform various functions of the selected object.

The bending sensor may be located at the whole side surface of the device 110 as shown in FIG. 15B. By mounting the bending sensor at the whole side surface, an accuracy of detecting a bending input may be higher than a case where the bending sensor is mounted at the side surface of the device 110 with a predetermined gap.

Referring back to FIG. 12, the bending input 140 detected by the bending detector 1220 may be identified according to a location, the number of times, an angle, a direction, and a hold time of reception of the bending input 140.

A memory 1230 may store information on objects 150 related to applications 120 which are executable in the device 110, in response to a touch input and a bending input. Each object 150 may include an execution result of a relevant application related to a corresponding application 120. In addition, each object 150 may be displayed on the touch screen 1210 so as to execute an additional function related to the corresponding application 120 while the corresponding application 120 is being executed. Information on relevant applications and additional functions related to the applications 120 may be stored in the memory 1230 in advance.

A controller 1240, i.e. a control unit, may display the object 150 on the touch screen 1210 according to the touch input 130 and the bending input 140 based on the information stored in the memory 1230. The controller may be implemented as a hardware, a software, or a combination of hardware and software, such as, as non-limiting examples, a.

When the touch input 130 and the bending input 140 of the user are received, the controller 1240 may select the object 150 related to the application 120 displayed on the touch screen 1210, based on the information on the objects 150, which is stored in the memory 1230.

In addition, the controller 1240 may identify a location where the touch input 130 is received and may determine a region in which the selected object 150 is to be displayed, based on the identified location. The selected object 150 may be displayed in the determined region.

When the selected object 150 is a plurality of objects 150, the plurality of objects 150 may be sequentially displayed on the touch screen 1210 in a preset order. Alternatively, the plurality of objects 150 may be sequentially displayed based on an input of the user.

An apparatus according to the present invention may include a processor, a memory for storing and executing program data, a permanent storage such as a disk drive, a communication port for performing communication with an external device, and a user interface, such as a touch panel, a key, and a button. Methods implemented with a software module or an algorithm may be stored in a computer-readable recording medium in the form of computer-readable codes or program instructions executable in the processor. Examples of the computer-readable recording medium include magnetic storage media (e.g., read-only memory (ROM), random-access memory (RAM), floppy disks, hard disks, etc.) and optical recording media (e.g., CD-ROMs, Digital Versatile Discs (DVDs), etc.). The computer-readable recording medium can also be distributed over network coupled computer systems so that the computer-readable code is stored and executed in a distributed fashion. The media can be read by a computer, stored in the memory, and executed by the processor.

All cited references including publicized documents, patent applications, and patents cited in the present application can be combined by individually and concretely merging each cited reference and the shown by generally merging each cited reference in the present application.

For the understanding of the present application, reference numerals are disclosed in the exemplary embodiments shown in the drawings, and specific terms are used to describe one or more exemplary embodiments. However, the present invention is not limited by the specific terms, and the present invention may include all components, which can be commonly thought by those of ordinary skill in the art.

One or more exemplary embodiments can be represented with functional blocks and various processing steps. These functional blocks can be implemented by various numbers of hardware and/or software configurations for executing specific functions. For example, the present invention may adopt direct circuit configurations, such as memory, processing, logic, and look-up table, for executing various functions under control of one or more processors or by other control devices. Like components being able to execute the various functions with software programming or software elements, one or more exemplary can be implemented by a programming or scripting language, such as C, C++, Java, or assembler, with various algorithms implemented by a combination of a data structure, processes, routines, and/or other programming components. Functional aspects can be implemented with algorithms executed in one or more processors. In addition, the present invention may adopt the prior art for electronic environment setup, signal processing and/or data processing. The terms, such as “mechanism”, “element”, “means”, and “configuration”, can be widely used and are not delimited as mechanical and physical configurations. The terms may include the meaning of a series of routines of software in association with a processor.

Specific executions described above are exemplary embodiments and do not limit the scope of the present invention even in any method. For conciseness of the specification, disclosure of conventional electronic configurations, control systems, software, and other functional aspects of the systems may be omitted. In addition, connections or connection members of lines between components shown in the drawings illustrate functional connections and/or physical or circuit connections, and the connections or connection members can be represented by replaceable or additional various functional connections, physical connections, or circuit connections in an actual apparatus. In addition, if there is no concrete use of terms such as “requisite” or “important” to refer to a component, that component may not be necessarily required for application of one or more exemplary embodiments.

The use of the term “said” or a similar directional term in the specification (in particular, in claims) may correspond to both the singular and the plural. In addition, when a range is disclosed in the present invention, inventions to which individual values belonging to the range are applied are included (if there is no disclosure opposed to this), and this is the same as if each of the individual values forming the range is disclosed in the detailed description. Finally, for steps forming the methods according to the present invention, if an order is not clearly disclosed or, if there is no disclosure opposed to the clear order, the steps can be performed in any order deemed proper. The present invention is not necessarily limited to the disclosed order of the steps. The use of all illustrations or illustrative terms (for example, and so forth, etc.) in the present invention is simply to describe the present invention in detail, and the scope of the present invention is not limited due to the illustrations or illustrative terms unless they are limited by claims. In addition, it will be understood by those of ordinary skill in the art that various modifications, combinations, and changes can be formed according to design conditions and factors within the scope of the attached claims or the equivalents.

In addition, other exemplary embodiments can also be implemented through computer-readable code/instructions in/on a medium, e.g., a computer readable medium, to control at least one processing element to implement any above described embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer-readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the present invention as defined by the following claims.

What is claimed is:

1. A method of displaying an object by a device, the method comprising:
receiving a touch input and a bending input;
selecting an object related to an application displayed on a screen of the device in response to the receiving the touch input and the bending input; and
displaying the selected object at a predetermined location on the screen,
wherein the predetermined location is based on a location on the screen where the touch input is received.

2. The method of claim 1, wherein the bending input comprises at least one of bending the device and unbending the device.

3. The method of claim 1, wherein the selecting further comprises detecting a difference between a time the touch input is received and a time the bending input is received, and
wherein the object is selected when the reception time difference is less than or equal to a predetermined threshold.

4. The method of claim 2, wherein the selecting comprises:
identifying a type of the bending input according to at least one of a location, a number of times, an angle, a direction, and a hold time of the received bending input; and
selecting the object based on the identified type of the bending input.

5. The method of claim 1, wherein the object comprises information regarding the execution of an additional function related to the application while the application is being executed, and
wherein the additional function is set in advance for the application.

6. The method of claim 1, wherein the object comprises an execution result of a relevant application related to the application, and
wherein the relevant application is set in advance for the application.

7. The method of claim 1, wherein the selecting comprises selecting a plurality of objects, and
wherein the displaying further comprises sequentially displaying the plurality of objects on the screen in a preset order.

8. The method of claim 7, wherein the plurality of objects are sequentially displayed based on user input.

9. The method of claim 1, wherein the displaying further comprises:
identifying a location of the received touch input;
determining a region in which the object is to be displayed, based on the identified location; and
displaying the object in the determined region.

10. The method of claim 1, wherein the displaying further comprises removing the object from the screen in response to a display end signal being received, and
the display end signal being generated in response to at least one of a touch input and a bending input being received by the device on which the object is displayed is received.

11. A device for displaying an object, the device comprising:
a touch screen configured to receive a touch input;
a bending detector configured to detect a bending input; and
a controller configured to select an object related to an application displayed on the touch screen of the device in response to the reception of the touch input and the bending input, and to display the selected object at a predetermined location on the touch screen,
wherein the predetermined location is based on a location on the touch screen where the touch input is received.

12. The device of claim 11, wherein the bending input comprises at least one of bending the device and unbending the device.

13. The device of claim 11, wherein the controller is further configured to detect a difference between a time the touch input is received and a time the bending input is received and to select the object when the reception time difference is less than or equal to a predetermined threshold.

14. The device of claim 12, wherein the controller is further configured to identify a type of the bending input according to at least one of a location, a number of times, an angle, a direction, and a hold time of the received bending input and to select the object based on the identified type of the bending input.

15. The device of claim 11, wherein the object comprises information regarding the execution of an additional function related to the application while the application is being executed, and
wherein the additional function is set in advance for the application.

16. The device of claim 11, wherein the object comprises an execution result of a relevant application related to the application, and
wherein the relevant application is set in advance for the application.

17. The device of claim 11, wherein the controller is further configured to select a plurality of objects and to sequentially display the plurality of objects on the touch screen in a preset order.

18. The device of claim 17, wherein the controller is further configured to sequentially display the plurality of objects based on user input.

19. The device of claim 11, wherein the controller is further configured to identify a location of the received touch input, determine a region in which the object is to be displayed, based on the identified location, and display the object in the determined region.

20. The device of claim 11, wherein the controller is further configured to remove the object from the screen in response to a display end signal being received, and
wherein the display end signal is generated in response to at least one of a touch input being received by the touch screen and a bending input being detected by the bending detector.

21. A non-transitory computer-readable storage medium having stored therein program instructions, which when executed by a computer, perform the method of claim 1.
